(19) United States
(12) Patent Application Publication
(10) Pub. No.: US 2025/0382411 A1
(43) Pub. Date: Dec. 18, 2025

(54) ADHESIVE FOR BONDING MEMBRANES MADE OF SOFT PVC

(71) Applicant: SIKA TECHNOLOGY AG, Baar (CH)

(72) Inventors: Matthias GÖSSI, Uster (CH); Christoph MAYER, Karlsruhe (DE); Ursula STADELMANN, Zürich (CH); Rui XU-RABL, Zürich (CH)

(73) Assignee: SIKA TECHNOLOGY AG, Baar (CH)

(21) Appl. No.: 19/109,256

(22) PCT Filed: Oct. 30, 2023
(86) PCT No.: PCT/EP2023/080199

§ 371 Date: Mar. 6, 2025

(30) Foreign Application Priority Data
Oct. 31, 2022 (EP) 22204771.4

(51) Int. Cl. C08G 59/50; C09J 163/00

(52) U.S. Cl. CPC C08G 59/5033; C08G 59/502; C09J 163/00

(57) ABSTRACT

An epoxy resin adhesive is used for bonding a membrane made of soft PVC to a further substrate, wherein the curing-agent component of the adhesive includes at least one amine A1 having at least one dimethylamino group and at least one amine hydrogen, and at least one further amine A2 having at least three amine hydrogens, and the curing-agent component includes, based on the total of all the liquid or dissolved constituents contained in the curing-agent component, an amine A1 content of 10 to 45 wt. %. The use allows bonding of untreated membranes made of soft PVC to form a stable, water-resistant adhesive bond and is particularly suitable for sealing tunnels, foundations and roofs.

### TECHNICAL FIELD

The invention relates to the bonding of soft PVC sealing membranes with epoxy resin-based adhesives.

### PRIOR ART

Polymer membranes for the sealing of foundations, dewatering systems, underground shafts, tunnels or routes often consist of soft PVC. In order to obtain a sealing surface, membranes are laid out in overlapping sheets and these are bonded to one another by a suitable method. Soft PVC membranes are usually laid in sheets and are typically welded for bonding of the sheets. This involves heating the lower membrane with hot air to such an extent that the PVC is partly melted, and pressing it together with the upper membrane such that the two membranes are bonded by a weld seam after cooling. In order to obtain an impervious surface, double seams are usually welded, which can be checked for leaks by means of compressed air. This procedure is quite laborious and is not possible in the case of certain coated membranes. As an alternative to welding, it is also possible to bond membranes. In tunnel construction or in the sealing of foundations, the membranes are also additionally bonded to the built structure, typically to a concrete or mortar substrate. However, the bonding of soft PVC membranes with prior art adhesives is unsatisfactory since these have only weak adhesion to soft PVC and/or become detached again over time. The epoxy resin adhesives used in construction for a wide variety of different applications generally have sustained resistance to the influence of moisture and develop high bond strengths on a wide variety of different substrates, such as concrete, mortar, steel or glass fiber-or carbon fiber-reinforced composite materials. However, they typically show inadequate adhesion on untreated soft PVC.

In order to achieve good adhesion with epoxy resin adhesives, it is possible to pretreat PVC membranes by means of an adhesion-promoting coating, or specially coated membrane strips are used, which can be bonded with epoxy resin adhesives. Such specially coated membrane strips are welded to the PVC membrane in order to enable bonding of the membrane to the substrate. However, this method is very laborious, and it would thus be advantageous to have adhesives that enable permanent bonding, resistant to the influence of moisture, of soft PVC membranes that have not been specially pretreated.

The prior art discloses the use of amines containing dimethylamino groups, such as 3-(3-dimethylaminopropylamino)propylamine, as co-curing agents for epoxy resins for achievement of high compressive strengths, for example in EP 3,336,120.

### SUMMARY OF THE INVENTION

It is therefore an object of the present invention to provide an adhesive for bonding of soft PVC membranes, which enables, even without laborious pretreatment or coating of the membrane, a long-lived, durable adhesive bond with high resistance to the influence of heat and moisture.

This object is surprisingly achieved by the use of an adhesive as claimed in claim 1. The epoxy resin adhesive used here comprises a curing agent component containing at least one amine A1 having at least one dimethylamino group and at least one amine hydrogen, and at least one further amine A2 having at least three amine hydrogens, where the content of amines A1 is 10% to 45% by weight, preferably 15% to 40% by weight, based on the sum total of all liquid or dissolved constituents present in the curing agent component. Surprisingly, such a combination of amines enables good adhesion to untreated soft PVC membranes, with simultaneously high resistance of the bond to the influence of moisture. Corresponding adhesives having a lower content of amine A1 show inadequate or zero adhesion to soft PVC, while adhesives having a higher content of amine A1 result in bonds having inadequate water resistance. In addition, it has been found that amines having dimethylamino groups that are free of amine hydrogens likewise result in bonds having inadequate water resistance. In a particularly preferred embodiment of the invention, the amine A2 used is a combination of at least one amine A2-1 having an amine hydrogen equivalent weight of at least 80 g/eq, preferably at least 90 g/eq, and an amine A2-2 having two primary amino groups and four amine hydrogens. Such a curing agent enables low-emission adhesives having a high filler content and very good adhesion to soft PVC, which are particularly suitable for the bonding of soft PVC to concrete or mortar surfaces. Particularly suitable combinations here are those of 3-(3-dimethylaminopropylamino) propylamine as amine A1, isophoronediamine as amine A2-2 and at least one amine selected from phenalkamines, phenalkamides and amine-functional adducts of N-benzylethane-1,2-diamine with polyepoxides as amine A2-1.

The inventive use enables bonding of soft PVC membranes to a multitude of substrates, especially to concrete or mortar, as customary in tunnel construction for example. In particular, it is also possible to bond soft PVC sealing membranes that have not been specially coated, without further pretreatment, directly and permanently to concrete, mortar or other substrate surfaces. In addition, the inventive use enables the bonding of soft PVC membranes to one another and the bonding of soft PVC membranes to other membranes, for example those made from polyolefin, especially surface-modified polyethylene. The adhesive bond obtained here is stable and resistant to heat and moisture. In particular, the adhesive bond, after storage at 70° C. and 100% relative humidity for 28 days, has a peel strength of at least 1 N/mm, preferably at least 1.5 N/mm. Further aspects of the invention are the subject of further independent claims. Particularly preferred embodiments of the invention are the subject of the dependent claims.

### WAYS OF EXECUTING THE INVENTION

The invention provides for the use of an adhesive for bonding a soft PVC membrane to a further substrate, characterized in that the adhesive comprises
a resin component comprising at least one epoxy resin and
a curing agent component comprising
   (a) at least one amine A1 having at least one dimethylamino group and at least one amine hydrogen, and
   (b) at least one further amine A2 which has at least three amine hydrogens and is free of dimethylamino groups,
      wherein the curing agent component, based on the sum total of all liquid or dissolved constituents present in the curing agent component, has a content of amines A1 of 10% to 45% by weight.

“Membrane” refers to a pliable polymer film as typically used for the sealing of underground built structures, tunnels or roofs.

“PVC” refers to a flexible, plasticizer-containing polyvinylchloride plastic.

“Dimethylamino group” refers to an amino group of the formula

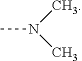

“Amine hydrogen” refers to the hydrogen atoms of primary and secondary amine groups.

“Amine hydrogen equivalent weight” refers to the mass of an amine or an amine-containing composition that contains one molar equivalent of amine hydrogen. It is expressed in units of “g/eq”.

The “sum total of all liquid or dissolved constituents present in the curing agent component” relates to the curing agent component minus any solids, especially fillers, present therein.

A “primary amino group” refers to an amino group which is bonded to a single organic radical and bears two hydrogen atoms; a “secondary amino group” refers to an amino group which is bonded to two organic radicals that may also together be part of a ring and bears one hydrogen atom; and a “tertiary amino group” refers to an amino group which is bonded to three organic radicals, two or three of which may also be part of one or more rings, and does not bear any hydrogen atom.

“Epoxy equivalent weight” refers to the mass of an epoxy group-containing compound or composition that contains one molar equivalent of epoxy groups. It is expressed in units of “g/eq”.

Substance names beginning with “poly”, such as polyamine or polyepoxide, refer to substances that formally contain two or more of the functional groups that occur in their name per molecule.

A “thinner” refers to a substance that is soluble in an epoxy resin and lowers its viscosity, and that is not chemically incorporated into the epoxy resin polymer during the curing process.

The “pot life” of an adhesive refers to the maximum period of time from the mixing of the components and the application of the adhesive, in which the mixed adhesive is in a sufficiently free-flowing state and has good ability to wet the substrate surfaces.

“Open time” of an adhesive refers to the maximum length of time between application of the adhesive and the joining of the parts to be bonded in which it is still possible to form a cohesive bond.

“Molecular weight” refers to the molar mass (in grams per mole) of a molecule.

“Average molecular weight” refers to the number-average Mₙ of a polydisperse mixture of oligomeric or polymeric molecules, which is typically determined by gel-permeation chromatography (GPC) against polystyrene as standard.

“Room temperature” refers to a temperature of 23° C.

All industry standards and norms mentioned in the document refer to the versions valid at the date of first filing, unless otherwise stated.

Percentages by weight (% by weight) refer to the proportions by mass of a constituent in a composition based on the overall composition, unless otherwise stated. The terms “mass” and “weight” are used synonymously in the present document.

The resin agent and the curing agent component of the adhesive are stored separately in separate containers and are mixed with one another only shortly before or during application.

A suitable epoxy resin is obtained in a known manner, in particular from the oxidation of olefins or from the reaction of epichlorohydrin with polyols, polyphenols or amines.

Preference is given to aromatic epoxy resins, especially the glycidyl ethers of:
bisphenol A, bisphenol F or bisphenol A/F, where A stands for acetone and F for formaldehyde used as reactants in the preparation of these bisphenols. In the case of bisphenol F, positional isomers may also be present, especially ones derived from 2,4′-or 2,2′-hydroxyphenylmethane,
dihydroxybenzene derivatives such as resorcinol, hydroquinone or catechol,
further bisphenols or polyphenols such as bis (4-hydroxy-3-methylphenyl)methane, 2,2-bis(4-hydroxy-3-methylphenyl)propane (bisphenol C), bis(3,5-dimethyl-4-hydroxyphenyl)methane, 2,2-bis(3,5-dimethyl-4-hydroxyphenyl)propane, 2,2-bis(3,5-dibromo-4-hydroxyphenyl)propane, 2,2-bis(4-hydroxy-3-tert-butylphenyl)propane, 2,2-bis(4-hydroxyphenyl)butane (bisphenol B), 3,3-bis(4-hydroxyphenyl)pentane, 3,4-bis(4-hydroxyphenyl)hexane, 4,4-bis(4-hydroxyphenyl)heptane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane (bisphenol Z), 1,1-bis(4-hydroxyphenyl)-3,3,5-trimethylcyclohexane (bisphenol TMC), 1,1-bis (4-hydroxyphenyl)-1-phenylethane, 1,4-bis [2-(4-hydroxyphenyl)-2-propyl]benzene (bisphenol P), 1,3-bis[2-(4-hydroxyphenyl)-2-propyl]benzene (bisphenol M), 4,4′-dihydroxydiphenyl (DOD), 4,4′-dihydroxybenzophenone, bis(2-hydroxynaphth-1-yl)methane, bis(4-hydroxynaphth-1-yl)methane, 1,5-dihydroxynaphthalene, tris(4-hydroxyphenyl)methane, 1,1,2,2-tetrakis (4-hydroxyphenyl)ethane, bis(4-hydroxyphenyl)ether or bis (4-hydroxyphenyl) sulfone,
novolaks, which are especially condensation products of phenol or cresols with formaldehyde or paraformaldehyde or acetaldehyde or crotonaldehyde or isobutyraldehyde or 2-ethylhexanal or benzaldehyde or furfural,
aromatic amines such as aniline, toluidine, 4-aminophenol, 4,4′-methylenediphenyldiamine, 4,4′-methylenediphenyldi(N-methyl)amine, 4,4′-[1,4-phenylenebis(1-methylethylidene)]bisaniline (bisaniline P) or 4,4′-[1,3-phenylenebis(1-methylethylidene)]bisaniline (bisaniline M).

Further suitable epoxy resins are aliphatic or cycloaliphatic polyepoxides, especially
glycidyl ethers of saturated or unsaturated, branched or unbranched, cyclic or open-chain di-, tri-or tetrafunctional C₂ to C₃₀ alcohols, especially ethylene glycol, propylene glycol, butylene glycol, hexanediol, octanediol, polypropylene glycols, dimethylolcyclohexane, neopentyl glycol, dibromoneopentyl glycol, castor oil, trimethylolpropane, trimethylolethane, pentaerythritol, sorbitol or glycerol, or alkoxylated glycerol or alkoxylated trimethylolpropane;
a hydrogenated bisphenol A, F or A/F liquid resin, or the glycidylation products of hydrogenated bisphenol A, F or A/F;
an N-glycidyl derivative of amides or heterocyclic nitrogen bases, such as triglycidyl cyanurate or triglycidyl isocyanurate, or reaction products of epichlorohydrin with hydantoin.
epoxy resins from the oxidation of olefins such as in particular vinylcyclohexene, dicyclopentadiene, cyclohexadiene, cyclododecadiene, cyclododecatriene, isoprene, 1,5-hexadiene, butadiene, polybutadiene or divinylbenzene.

Further suitable epoxy resins are those from the reaction of biobased hydroxy-functional raw materials with epichlorohydrin, especially vanillin-based epoxy resins such as, in particular, diglycidyl ethers of vanillin alcohol, or glycerol-based epoxy resins.

The epoxy resin is preferably a liquid resin or a mixture comprising two or more liquid epoxy resins.

“Liquid epoxy resin” refers to an industrial polyepoxide having a glass transition temperature below 25° C.

The resin component optionally additionally contains proportions of solid epoxy resin.

The resin component more preferably contains at least one aromatic liquid epoxy resin, especially a bisphenol A diglycidyl ether, a bisphenol F diglycidyl ether or a phenol-formaldehyde novolak glycidyl ether, where the phenol-formaldehyde novolak glycidyl ether preferably has an average functionality in the range from 2.3 to 4, preferably 2.5 to 3. These epoxy resins are very hydrophobic and have a low viscosity for epoxy resins. They enable good processibility, rapid curing and high bond strengths.

The aromatic liquid epoxy resin preferably has an average epoxy equivalent weight of 150 to 250 g/eq.

The resin component preferably additionally contains at least one reactive diluent containing epoxy groups.

The following are especially suitable for this purpose: butane-1,4-diol diglycidyl ether, hexane-1,6-diol diglycidyl ether, trimethylolpropane di-or triglycidyl ether, phenyl glycidyl ether, cresyl glycidyl ether, guaiacol glycidyl ether, 4-methoxyphenyl glycidyl ether, p-n-butylphenyl glycidyl ether, p-tert-butylphenyl glycidyl ether, 4-nonylphenyl glycidyl ether, 4-dodecylphenyl glycidyl ether, cardanol glycidyl ether, benzyl glycidyl ether, allyl glycidyl ether, butyl glycidyl ether, hexyl glycidyl ether, 2-ethylhexyl glycidyl ether, or glycidyl ethers of natural alcohols, such as in particular C₈ to C₁₀ or C₁₂ to C₁₄ or C₁₃ to C₁₅ alkyl glycidyl ethers.

Preferred reactive diluents are butane-1,4-diol diglycidyl ether, hexane-1,6-diol diglycidyl ether, p-tert-butylphenyl glycidyl ether, cardanol glycidyl ether or C₈ to C₁₀ or C₁₂ to C₁₄ or C₁₃ to C₁₅ alkyl glycidyl ethers.

Particular preference is given to butane-1,4-diol diglycidyl ether and/or hexane-1,6-diol diglycidyl ether. Such an adhesive enables particularly high bond strengths to soft PVC membranes, coupled with good water resistance of the bond.

The weight ratio between aromatic liquid epoxy resins and reactive diluents containing epoxy groups is preferably in the range from 60/40 to 95/5, especially 70/30 to 95/10.

The curing agent component contains at least one amine A1 having at least one dimethylamino group and at least one amine hydrogen. Such an amine enables particularly good adhesion on soft PVC and is incorporated into the polymer network when the adhesive is cured.

The amine A1 is preferably selected from the group consisting of 2-dimethylaminoethylamine, 3-dimethylaminopropylamine (DMAPA), 4-dimethylaminobutylamine, 6-dimethylaminohexylamine, 2-(2-dimethylaminoethylamino)ethylamine, 2-(3-dimethylaminopropylamino)ethylamine, 3-(2-dimethylaminoethylamino)propylamine, 3-(3-dimethylaminopropylamino)propylamine (DMAPAPA), N-(3-dimethylaminopropyl)-1,3-bis(aminomethyl)benzene, N-(3-dimethylaminopropyl)-1,4-bis(aminomethyl)benzene, 2,4,6-tris(4-dimethylamino-2-azabutyl)phenol, bis (2-dimethylaminoethyl)amine, bis(3-dimethylaminopropyl) amine and bis(6-dimethylaminohexyl)amine.

The amine A1 preferably contains at least two amine hydrogens, especially at least three amine hydrogens.

The most preferred amine A1 is 3-(3-dimethylaminopropylamino) propylamine (DMAPAPA). It has low odor, is toxicologically advantageous, has good commercial availability and enables very high bond forces coupled with good water stability of the bond.

A further preferred amine A1 is 3-dimethylaminopropylamine (DMAPA). It has a particularly high concentration of dimethylamino groups and is commercially readily available.

Another preferred amine A1 is N-(3-dimethylaminopropyl)-1,3-bis(aminomethyl)benzene. It has particularly low odor, is obtainable from the reductive alkylation of 3-dimethylaminopropylamine with 3-cyanobenzaldehyde, and enables particularly high bond strengths coupled with good water stability of the bond.

The adhesive preferably contains such an amount of amine A1 that the curing agent component, based on the sum total of all liquid or dissolved constituents present in the curing agent component, has a content of amines A1 of 15% to 40% by weight. Any fillers present in the curing agent component are thus not included in the calculation. Such an amount of amine A1 enables a particularly advantageous combination of high bond strength and good water stability of the bond.

Also preferably, the adhesive contains such an amount of amine A1 that the number of amine hydrogen equivalents from amines A1 based on the total number of amine hydrogen equivalents in the curing agent component is in the range from 20% to 60%, preferably 25% to 55%. Such an amount of amine A1 enables a particularly advantageous combination of high bond strength and good water stability of the bond.

The curing agent component contains at least one further amine A2 which has at least three amine hydrogens and is free of dimethylamino groups. Such an amine enables high bond strength coupled with good stability to the influence of moisture.

Suitable amines A2 are commercial polyamines having aliphatically bonded amino groups, as typically used for curing of epoxy resins. The amine A2 is preferably selected from the group consisting of 1,5-diamino-2-methylpentane (MPMD), hexane-1,6-diamine, 2,2(4),4-trimethylhexane-1,6-diamine (TMD), 2-butyl-2-ethylpentane-1,5-diamine (C11 neodiamine), isophoronediamine (IPDA), 1,3-bis(aminomethyl)benzene (MXDA), 1,4-bis(aminomethyl)benzene, 2,5-bis(aminomethyl)furan, 2,5-bis(aminomethyl)tetrahydrofuran, 1,3-bis(aminomethyl)cyclohexane (BAC), 1,4-bis(aminomethyl)cyclohexane, bis(4-aminocyclohexyl)methane, 1,2-diaminocyclohexane (DACH), 1,3-diaminocyclohexane, 1,4-diaminocyclohexane, 2(4)-methyl-1,3-diaminocyclohexane (MCDA), 2,5(2,6)-bis(aminomethyl)bicyclo[2.2.1]heptane (NBDA), N-benzylethane-1,2-diamine, N-furfurylethane-1,2-diamine, N-tetrahydrofurfurylethane-1,2-diamine, diethylenetriamine (DETA), triethylenetetramine (TETA), tetraethylenepentamine (TEPA), dipropylenetriamine (DPTA), N-(2-aminoethyl)propane-1,3-diamine (N3 amine), N,N′-bis(3-aminopropyl)ethylenediamine (N4 amine), bis(1,6-hexylene)triamine (BHMT), phenalkamines, phenalkamides, polyamidoamines, amine-functional adducts of the amines mentioned with epoxides, and combinations of two or more of these amines.

Suitable phenalkamines are especially reaction products of cardanol with formaldehyde and polyamines. Suitable phenalkamides are especially phenalkamines that additionally contain amide groups. Suitable polyamidoamines are especially reaction products of dimer fatty acids with polyalkyleneamines such as, in particular, DETA, TETA or TEPA.

Particular preference is given to IPDA, MXDA, BAC, DACH, MCDA, N-benzylethane-1,2-diamine, amine-functional adducts of N-benzylethane-1,2-diamine with polyepoxides, DETA, TETA, TEPA, DPTA, N3 amine, N4 amine, phenalkamines, phenalkamides, and combinations of two or more of these amines.

Particular preference is given to IPDA.

Particular preference is also given to N-benzylethane-1,2-diamine.

Particular preference is also given to amine-functional adducts of N-benzylethane-1,2-diamine with at least one polyepoxide, especially an aromatic liquid epoxy resin. These adducts are of particularly low viscosity, are producible in high concentration even without solvents or thinners, and enable high water resistance of the bond.

Particular preference is also given to phenalkamines or phenalkamides, in particular solvent-free phenalkamines or phenalkamides, as sold commercially by Cardolite, especially phenalkamides such as Cardolite® LITE 3025, LITE 3040 or LITE 3060 (all from Cardolite).

In a preferred embodiment, the curing agent component contains, as amine A2, at least one amine A2-1 having an amine hydrogen equivalent weight of at least 80 g/eq, preferably at least 90 g/eq. Such an amine enables adhesives having a high filler content and low content of thinners.

A particularly suitable amine A2-1 is a phenalkamine or phenalkamide or an amine-functional adduct of N-benzylethane-1,2-diamine with at least one polyepoxide, especially an aromatic liquid epoxy resin. These amines are hydrophobic and of comparatively low viscosity, and enable low-emission adhesives having high resistance to humidity.

In a particularly preferred embodiment, the amine A2 present in the curing agent component is a combination of at least one amine A2-1 as described above and at least one amine A2-2 having two primary amino groups and four amine hydrogens.

The amine A2-2 is preferably selected from IPDA, MXDA, BAC, DACH and MCDA, and IPDA is the most preferred.

In the most preferred embodiment, the curing agent component contains a combination of 3-(3-dimethylaminopropylamino) propylamine (DMAPAPA), isophoronediamine (IPDA) and at least one amine selected from phenalkamines, phenalkamides and amine-functional adducts of N-benzylethane-1,2-diamine with at least one aromatic liquid epoxy resin.

The preferred amines and amounts enable adhesives having particularly high bond strengths, coupled with high resistance of the bond to moisture.

The adhesive preferably contains further ingredients, where these are present as a constituent of the resin component and/or of the curing agent component and/or as a further separate component. Constituents reactive toward amine hydrogens are preferably present as a constituent of the resin component. Constituents reactive toward epoxy groups are preferably present as a constituent of the curing agent component.

The adhesive preferably contains at least one further ingredient selected from thinners, fillers, accelerators and surface-active compounds.

Suitable thinners are especially those having a boiling point of at least 200° C. at standard pressure, especially 2-phenoxyethanol, 2-benzyloxyethanol, benzyl alcohol, ethylene glycol dibutyl ether, ethylene glycol diphenyl ether, diethylene glycol, diethylene glycol monoethyl ether, diethylene glycol mono-n-butyl ether, diethylene glycol di-n-butyl ether, propylene glycol phenyl ether, dipropylene glycol, dipropylene glycol di-n-butyl ether, diphenylmethane, diisopropylnaphthalene, propylated biphenyl, tert-butylphenol, nonylphenol, dodecylphenol, cardanol (from cashew nut shell oil, containing as its main constituents 3-(7-pentadecenyl) phenol, 3-(7,10,14-pentadecatrienyl) phenol and 3-(7,10-pentadecadienyl) phenol), styrenated phenol, bisphenols, aromatic hydrocarbon resins, especially types that contain phenol groups, adipates, sebacates, phthalates, benzoates, organic phosphoric or sulfonic esters or sulfonamides.

Preference is given to benzyl alcohol, styrenated phenol, ethoxylated phenol such as, in particular, 2-phenoxyethanol, aromatic hydrocarbon resins containing phenol groups, especially the Novares® LS 500, LX 200, LA 300 or LA 700 grades (from Rütgers), diisopropylnaphthalene, propylated biphenyl or cardanol.

The adhesive preferably contains only a low content of thinners. The adhesive preferably contains, based on 100 parts by weight of the sum total of all constituents containing epoxy and amine groups, not more than 30 parts by weight, especially not more than 25 parts by weight, preferably not more than 20 parts by weight, more preferably not more than 10 parts by weight, especially not more than 5 parts by weight, of thinner. This enables bonds having particularly high resistance to moisture.

Suitable fillers are, in particular, ground or precipitated calcium carbonates, optionally coated with fatty acid, especially stearates, baryte (heavy spar), talc, ground quartz, quartz sand, silicon carbide, iron mica, dolomite, wollastonite, kaolin, mica (potassium aluminum silicate), molecular sieve, aluminum oxide, aluminum hydroxide, magnesium hydroxide, silica, cement, gypsum, fly ash, carbon black, graphite, metal powders such as aluminum, copper, iron, zinc, silver or steel, PVC powder or hollow beads.

The adhesive preferably contains mineral fillers, especially selected from calcium carbonate, baryte, talc, ground quartz, quartz sand, kaolin and combinations of these fillers.

The adhesive preferably contains, based on the overall adhesive, 60% to 90% by weight, especially 70% to 85% by weight, of mineral fillers.

Suitable accelerators are especially acids or compounds that are hydrolyzable to acids, in particular organic carboxylic acids such as acetic acid, benzoic acid, salicylic acid, 2-nitrobenzoic acid, lactic acid, organic sulfonic acids such as methanesulfonic acid, p-toluenesulfonic acid or 4-dodecylbenzenesulfonic acid, sulfonic esters, other organic or inorganic acids or acid esters; and also nitrates such as, in particular, calcium nitrate; tertiary amines, imidazoles, ammonium salts, amidines, guanidines, phenols, phenolic resins or Mannich bases such as, in particular, 2,4,6-tris(dimethylaminomethyl)phenol, or compounds having mercapto groups.

Preference is given to acids, nitrates, tertiary amines or Mannich bases, especially salicylic acid, calcium nitrate or 2,4,6-tris(dimethylaminomethyl)phenol, or a combination of these accelerators.

Suitable surface-active compounds are in particular thickeners, wetting agents, defoamers or deaerators.

The adhesive is preferably not water-based. It preferably contains less than 5% by weight, especially less than 1% by weight, of water, based on the overall adhesive.

The adhesive optionally contains further auxiliaries and additives, such as, in particular,
further reactive diluents, especially epoxidized soybean oil or linseed oil, compounds containing acetoacetate groups, butyrolactone, carbonates, aldehydes, isocyanates or silicones having reactive groups,
solvents,
further amines, in particular aromatic polyamines such as, in particular, 4,4′-, 2,4′ and/or 2,2′-diaminodiphenylmethane, toluene-2,4- and/or -2,6-diamine, 3,5-dimethylthiotoluene-2,4-and/or-2,6-diamine, 3,5-diethyltoluene-2,4- and/or -2,6-diamine,
further compounds having dimethylamino groups, especially (meth)acrylamides such as, in particular, 3-dimethylaminopropylmethacrylamide,
compounds having mercapto groups, especially liquid mercaptan-terminated polysulfide polymers, mercaptan-terminated polyoxyalkylene ethers, mercaptan-terminated polyoxyalkylene derivatives, polyesters of thiocarboxylic acids, 2,4,6-trimercapto-1,3,5-triazine, triethylene glycol dimercaptan or ethanedithiol,
polymers, especially polyamides, polysulfides, polyvinyl formal (PVF), polyvinyl butyral (PVB), polyurethanes (PUR), polymers having carboxyl groups, polyamides, butadiene-acrylonitrile copolymers, styrene-acrylonitrile copolymers, butadiene-styrene copolymers, homo-or copolymers of unsaturated monomers, especially from the group comprising ethylene, propylene, butylene, isobutylene, isoprene, vinyl acetate or alkyl (meth) acrylates, especially chlorosulfonated polyethylenes or fluorine-containing polymers or sulfonamide-modified melamines,
fibers, especially glass fibers, carbon fibers, metal fibers, ceramic fibers, polymer fibers such as polyamide fibers or polyethylene fibers, or biobased fibers such as, in particular, wood fibers, cellulose fibers, hemp fibers, flax (linen), jute or coconut fibers,
nanofillers, especially carbon nanotubes,
pigments, especially titanium dioxide, iron oxides or chromium (III) oxide,
adhesion promoters, especially organoalkoxysilanes,
flame-retardant substances or
further additives, especially stabilizers against oxidation, heat, light or UV radiation or biocides.

A preferred adhesive for the inventive use contains, based on the overall adhesive,
10% to 20% by weight of aromatic liquid epoxy resins,
1% to 4% by weight of reactive diluent containing epoxy groups,
3-(3-dimethylaminopropylamino)propylamine,
isophoronediamine,
at least one amine A2-1 having an amine hydrogen equivalent weight of at least 80 g/eq, preferably at least 90 g/eq,
60% to 90% by weight of mineral fillers
   and optionally further ingredients.

The epoxy resins and the reactive diluents containing epoxy groups are a constituent of the resin component, the amines are a constituent of the curing agent component, and the mineral fillers and any other constituents present are a constituent of the resin component and/or of the curing agent component and may be present as a separate further component.

Suitable soft PVC membranes for the inventive use are commercial membranes as used for sealing of tunnels, foundations, bridges, roofs, silos, swimming pools, sedimentation tanks, ponds or other tanks. They consist largely of plasticized polyvinylchloride, typically with plasticizer contents of 20% to 50% by weight, based on the overall membrane. They especially have a thickness of 1 to 5 mm and are typically available in the form of rolled-up sheets in a width of about 0.2 to 3 m. For use, they are typically cut to the desired size and/or are bonded to one another by hot air welding.

The soft PVC membrane may contain an internal polyester weave or glass fiber nonwoven for reinforcement.

Some commercial soft PVC membranes have a visually different top side and bottom side. In the case of membranes that are used underground, for example for sealing of tunnels or foundations, the top side and bottom side typically have different pigmentation in order to maintain a better overview in the laying of the sheets. Sikaplan® WP 2110-21 HL (from Sika), for example, has a yellow-pigmented top side and a black-pigmented bottom side, and it is the black-pigmented bottom side that comes to rest on the substrate to be sealed.

Membranes for roof sealing also typically have a different-colored top side and bottom side. In the case of certain membranes for roof sealing, the top side has been coated with a particularly light-and UV-stable layer.

Particularly suitable soft PVC membranes for the inventive use are the Sika products available under the Sikaplan® or Sarnafil® brand names, for example Sikaplan® WP 1100, Sikaplan® WP 2110, Sarnafil® G 410 (with UV-stable surface seal), Sarnafil® S 327 (with UV-stable surface seal), Sikaplan® G, Sikaplan® VG, Sikaplan® SGmA, and also soft PVC membranes from other suppliers.

It is possible to bond either the top side or the bottom side of the membrane. It is typically the bottom side of the membrane that is bonded.

An essential aspect of the inventive use is that there is no need to use a soft PVC membrane having an adhesion-promoting surface coating in order to obtain a durable adhesive bond. In particular, there is no need to apply a primer or activator to the membrane prior to application of the adhesive. In addition, there is no need to use a specific membrane that has been provided with a surface coating over the full area or in partial regions in order to improve adhesion, as is the case, for example, in the case of Sikaplan® WP Tape-200 (from Sika).

Thus, the soft PVC membrane for the inventive use preferably does not have an adhesion-promoting surface coating.

But it may be advantageous to free the membrane of dust and soil prior to bonding, for example by blowing, suction or wiping, or cleaning with a solvent for example. If an unsoiled membrane is used freshly from the roll, there is typically no need for any such cleaning prior to use.

A suitable further substrate for the inventive use is in particular
a plastic, such as rigid and flexible PVC, polycarbonate, polystyrene, polyester, polyamide, PMMA, ABS, SAN, epoxy resins, phenolic resins, PUR, POM, TPO, PE, PP, EPM or EPDM, in each case untreated or surface-treated, for example by means of plasma, corona or flames;
concrete, mortar, cement screed, fiber cement, brick, tile, plaster, natural stone such as granite or marble, glass or glass ceramic;
asphalt or bitumen;
repair or leveling compounds based on PCC (polymer-modified cement mortar) or ECC (epoxy resin-modified cement mortar);
fiber-reinforced plastics, such as carbon fiber-reinforced plastics (CFRP), glass fiber-reinforced plastics (GFRP), natural fiber-reinforced plastics (NFRP) or sheet molding compounds (SMC);
leather, textiles, paper, wood, wood-based materials bonded with resins, for example phenolic, melamine or epoxy resins, resin-textile composites or further polymer composites;
metals or alloys such as aluminum, iron, steel, copper, other nonferrous metals, including surface-finished metals or alloys such as galvanized or chrome-plated metals;
insulation foams, especially made of EPS, XPS, PUR, PIR, rock wool, glass wool or foamed glass;
coated or painted substrates, especially painted tiles, painted concrete, powder-coated metals or alloys or painted metal sheets, especially polyvinylidene fluoride-coated sheets;
coatings, paints or varnishes, especially coated floors.

The further substrate may if required be pretreated prior to application of the adhesive, especially by physical and/or chemical cleaning methods or the application of an activator or a primer. It is preferably not pretreated apart from superficial cleaning, especially removal of dust.

The further substrate is preferably selected from soft PVC, polyolefin, modified polyethylene, concrete, mortar, cement screed, fiber cement, brick, tile, natural stone, steel, polyvinylidene fluoride-coated metals and further plastics.

In a preferred embodiment of the use, the further substrate is a further soft PVC membrane, or a membrane of a further plastic such as, in particular, polyolefin, for example Sikaplan® WT 1200 (from Sika), or a membrane of modified polyethylene, such as, in particular, Hypalon®.

In a particularly preferred embodiment of the use, the further substrate is an inflexible material having a firm surface, especially concrete, mortar, cement screed, fiber cement, brick, tile, natural stone, steel, polyvinylidene fluoride-coated metals or other plastics such as hard PVC, fiber-reinforced plastics or SMC, especially concrete, mortar or polyvinylidene fluoride-coated metals.

Polyvinylidene fluoride-coated metals are especially sheets, commercially available as Kynar® 500 (from Arkema) coated metal sheets, especially for roof coverage. The adhesive described has surprisingly good adhesion to such coated metal sheets, which is particularly advantageous, for example, in the case of transitions from inclined roof areas with Kynar® 500 metal coverage to flat roof areas sealed with PVC membrane, or in the case of flat roofs with Kynar® 500 metal frames, in order to permanently bond the two materials. The use of the adhesive for bonding of a soft PVC membrane to a polyvinylidene fluoride-coated metal is thus particularly preferred.

For the inventive use, the resin component and the curing agent component and any further components present in the adhesive are mixed by a suitable method. The mixing ratio is preferably chosen such that the molar ratio of epoxy-reactive groups to epoxy groups is in the range from 0.5 to 1.5, especially 0.7 to 1.2. In parts by weight, the mixing ratio between the resin component and the curing agent component is typically in the range from about 1:2 to 20:1, especially 1:1 to 5:1.

The components are mixed continuously or batchwise by means of a suitable method, taking care to ensure that not too much time passes between the mixing of the components and the application of the mixed adhesive, and that application thus takes place within the pot life of the adhesive. The adhesive is preferably mixed and applied at ambient temperature, which is typically in the range from about 5 to 40° C., preferably about 10 to 35° C.

For the inventive use, the mixed adhesive is applied to the soft PVC membrane and/or to the further substrate within the pot life. The adhesive is preferably applied manually with a spatula tool or a builder's trowel. Likewise possible is application from a cartridge or with a hydraulic delivery system.

The adhesive is preferably applied in such an amount that, after the substrates have been joined and pressed, the adhesive join has a thickness of 0.5 to 10 mm, preferably of 1 to 5 mm.

The soft PVC membrane may be bonded over the full area or only in one or more part-regions. The bonding is preferably effected in one or more part-regions.

After the mixed adhesive has been applied, the bond is joined within the open time of the adhesive. The pot life and open time of the adhesive depend on the ingredients thereof, the presence of accelerators, and the temperature. At room temperature, the open time is typically about 15 minutes to about 2 hours.

According to the geometry of the bond, it is advantageous when the bond is fixed by a suitable method after joining, in order to prevent movement of the joined parts if the adhesive has still not cured sufficiently to keep the joined parts in the chosen position.

The adhesive cures after the bond has been joined. The adhesive preferably likewise cures under ambient conditions.

The adhesive cures via chemical reaction of the ingredients. The amine hydrogens of primary and secondary amino groups and any other groups reactive toward epoxy groups react here with epoxy groups, with ring opening thereof. In addition, the dimethylamino groups present catalyze homopolymerization of the epoxy groups. As a result primarily of these reactions, the adhesive undergoes polymerization and hence curing. Curing typically extends over a few hours to days. The duration depends on factors including the temperature, the reactivity of the constituents, the stoichiometry thereof, and the presence/amount of accelerators.

The invention further provides an adhesive bond obtained from the use as described above.

The adhesive bond preferably has a layer thickness of the adhesive of 0.5 to 10 mm, especially 1 to 5 mm.

The adhesive bond preferably has a peel strength value of in each case at least 1 N/mm, preferably at least 1.5 N/mm, determined both after a) curing under standard climatic conditions for 7 days and b) curing under standard climatic conditions for 7 days, followed by storage at 70° C. and 100% relative humidity for 28 days, followed by storage under standard climatic conditions for 3 days. If the soft PVC membrane has been bonded to a further membrane, peel strength is determined to DIN EN 14173 at a strain rate of 100 mm/min.

If the soft PVC membrane has been bonded to a solid surface, peel strength is determined in accordance with DIN EN 14173 at a strain rate of 100 mm/min with a strain angle of 90° between the soft PVC membrane and the solid surface.

The resultant adhesive bond is preferably part of a seal of tunnels, foundations, archive rooms, service rooms, sports stadia, underground railway stations, underpasses, military installations, ponds, swimming pools, sedimentation tanks, silos, other tanks, terraces or parking decks.

The resultant adhesive bond is also preferably part of a roof seal, especially a seal of slightly inclined roof areas, especially flat roofs under load or flat roofs under mechanical stress.

The resultant adhesive bond is capable of bonding the bonded parts reliably and over the long term, and enables reliable sealing with respect to penetrating water and with respect to gases such as methane or radon.

### EXAMPLES

Working examples are adduced hereinafter, which are intended to further elucidate the invention described. The invention is of course not limited to these described working examples.

“AHEW” stands for amine hydrogen equivalent weight.

“EEW” stands for epoxy equivalent weight.

“Standard climatic conditions” (“SCC”) refers to a temperature of 23±1° C. and a relative air humidity of 50±5%.

The chemicals used were from Sigma-Aldrich Chemie GmbH, unless stated otherwise.

Substances and abbreviations used:

| | |
|---|---|
| BADGE | bisphenol A diglycidyl ether, EEW about 187 g/eq |
| | (Araldite ® GY 250, from Huntsman) |
| BD-DGE | butane-1,4-diol diglycidyl ether, EEW about 128 g/eq |
| | (Grilonit ® RV 1806, from EMS-Chemie) |
| HD-DGE | hexane-1,6-diol diglycidyl ether, EEW about 147 g/eq |
| | (Grilonit ® RV 1812, from EMS-Chemie) |
| DY-E | monoglycidyl ethers of C₁₂ to C₁₄ alcohols, EEW about |
| | 290 g/eq (Araldite ® DY-E, from Huntsman) |
| Rütasolv ® | propylated biphenyl (from Rutgers) |
| BP M | |
| DMAPAPA | 3-(3-dimethylaminopropylamino)propylamine, AHEW |
| | 53 g/eq (DMAPAPA, from Arkema) |
| DMAPA | 3-dimethylaminopropylamine, AHEW 51 g/eq (DMAPA, |
| | from Arkema) |
| DMAP-MXDA | N-(3-dimethylaminopropyl)-1,3-bis(aminomethyl)ben- |
| | zene, AHEW 73.7 g/eq, prepared as described below |
| IPDA | isophoronediamine, AHEW 42.6 g/eq (Vestamin ® IPD, |
| | from Evonik) |
| LITE 3025 | phenalkamide curing agent, AHEW about 103 g/eq |
| | (Cardolite ® LITE 3025, from Cardolite) |
| Adduct 1 | adduct of N-benzylethane-1,2-diamine onto bisphenol |
| | A diglycidyl ether, AHEW 116.6 g/eq, prepared as |
| | described below |
| Quartz flour | grain size 0 to 75 μm |
| Quartz sand | grain size 0.1 to 0.3 mm |
| Coated CaCO₃ | precipitated, surface-treated chalk (Winnofil ® |
| | SPT, from Imerys Performance Minerals) |

DMAP-MXDA: N-(3-Dimethylaminopropyl)-1,3-bis(aminomethyl)benzene 39.2 g (0.30 mol) of 3-formylbenzonitrile was dissolved in 750 ml of isopropyl alcohol, mixed with 32.0 g (0.315 mol) of 3-dimethylaminopropylamine (DMAPA, from Arkema) and stirred for 1 hour, then hydrogenated at 65° C., hydrogen pressure 75 bar and a flow rate of 5 ml/min in a continuous hydrogenation apparatus with a Raney nickel fixed bed catalyst, and the hydrogenated solution was concentrated on a rotary evaporator at 65° C., removing unreacted 3-dimethylaminopropylamine, water and isopropanol. The resulting reaction mixture was purified by distillation at 130° C. under reduced pressure. This afforded a colorless liquid having an N-dimethylaminopropyl-1,3-bis(aminomethyl)benzene content, determined by GC, of >97%, which was used hereinafter as DMAP-MXDA.

### Adduct-1:

An initial charge of 45.0 g (0.3 mol) of N-benzylethane-1,2-diamine was heated to 80° C. under a nitrogen atmosphere. To this was slowly added 36.8 g (0.2 mol of epoxy groups) of bisphenol A diglycidyl ether (Araldite® GY 250, from Huntsman) with good stirring, keeping the temperature of the reaction mixture between 70 and 90° C. for one hour. A clear, pale yellowish liquid was obtained.

### Production of Adhesives and Bonds:

### Examples 1 to 12

For each example, a resin component (Resin comp.) was produced by mixing the ingredients of the resin component specified in tables 1 and 2 in the specified amounts (in parts by weight) by means of a centrifugal mixer (SpeedMixer™ DAC 150, FlackTek Inc.) and storing it with exclusion of moisture.

In addition, for each example, a curing agent component (Curing comp.) was prepared by mixing the ingredients of the curing agent component specified in tables 1 and 2 in the amounts specified (in parts by weight) by means of the centrifugal mixer and storing it with exclusion of moisture.

For each example, the resin component and the curing agent component were then processed by means of the centrifugal mixer to get a homogeneous paste and this was immediately tested as follows:

Peel strength (T-Peel) was determined by bonding two membrane strips (Sikaplan WP 2110-21 HL, soft PVC sealing membrane for tunnel construction, from Sika) of 50×200 mm over an area of 50×150 mm with an adhesive thickness of 2 mm such that the two black sides were bonded to one another. For testing, the composite bodies, in accordance with DIN EN 14173, were pulled apart at a strain rate of 100 mm/min at an angle of 180°, and the strength in the middle 100 mm was evaluated. Peel strength was determined after curing under standard climatic conditions for 7 days (7d SCC), and after additional storage at 70° C. and 100% relative humidity for 28 days, followed by 3 days under standard climatic conditions (+28d 70/100).

The tensile strength of the adhesive was determined by applying the mixed adhesive under standard climatic conditions to a silicone mold to obtain dumbbell-shaped tensile specimens having a thickness of 10 mm and a length of 150 mm with a gage length of 80 mm and a gage width of 10 mm, removing these from the mold after 7 days and determining tensile strength according to EN ISO 527 at a strain rate of 1 mm/min.

The results are reported in Tables 1 and 2.

Examples labeled “(Ref.)” are comparative examples.

It is apparent from table 1 that an adhesive without DMAPAPA (=amine A1) (Example 1 (Ref.)) and an adhesive with too low a content of DMAPAPA (Example 2 (Ref.)) show inadequate peel strength/adhesion. Examples 3 and 4 with an inventive content of DMAPAPA, with peel strength values of more than 1 MPa, show good to very good adhesion to soft PVC, even after storage of the bond under moist/warm climatic conditions for 4 weeks. The adhesive from example 5 (Ref.) which has too high a DMAPAPA content does show very good adhesion to soft PVC after curing under standard climatic conditions, but peel strength/adhesion is inadequate after storage of the bond under moist/warm climatic conditions for 4 weeks. The bond has inadequate water resistance.

TABLE 1
Composition and properties of examples 1 to 8.

| | Example | | | | | | | |
|---|---|---|---|---|---|---|---|---|
| | 1 | 2 | | | 5 | | | |
| | (Ref.) | (Ref.) | 3 | 4 | (Ref.) | 6 | 7 | 8 |
| Resin comp. | | | | | | | | |
| BADGE | 41.0 | 41.0 | 41.0 | 41.0 | 41.0 | 41.0 | 41.0 | 41.0 |
| BD-DGE | 7.0 | 7.0 | 7.0 | 7.0 | 7.0 | 7.0 | 7.0 | 7.0 |
| Quartz flour | 20.0 | 20.0 | 20.0 | 20.0 | 20.0 | 20.0 | 20.0 | 20.0 |
| Quartz sand | 116.0 | 116.0 | 116.0 | 116.0 | 116.0 | 116.0 | 116.0 | 116.0 |
| Coated CaCO₃ | 16.0 | 16.0 | 16.0 | 16.0 | 16.0 | 16.0 | 16.0 | 16.0 |
| Curing comp. | | | | | | | | |
| DMAPAPA | — | 2.0 | 4.0 | 6.0 | 10.0 | 6.0 | 6.0 | 6.0 |
| IPDA | 9.0 | 8.0 | 6.5 | 5.0 | 2.0 | 2.3 | 3.8 | 3.4 |
| LITE 3025 | 7.0 | 5.0 | 5.0 | 5.0 | 4.0 | — | — | 4.5 |
| Adduct 1 | — | — | — | — | — | 12.7 | 8.5 | 4.5 |
| Benzyl alcohol | 5.0 | 6.0 | 5.5 | 5.0 | 5.0 | — | 2.7 | 2.6 |
| Quartz flour | 37.0 | 37.0 | 37.0 | 37.0 | 37.0 | 37.0 | 37.0 | 37.0 |
| Quartz sand | 25.5 | 25.5 | 25.5 | 25.5 | 25.5 | 25.5 | 25.5 | 25.5 |
| Coated CaCO₃ | 16.5 | 16.5 | 16.5 | 16.5 | 16.5 | 16.5 | 16.5 | 16.5 |
| Content of amine | — | 9.5% | 19.1% | 28.6% | 47.6% | 28.6% | 28.6% | 28.6% |
| A1 ¹ | | | | | | | | |
| Proportion of AH | — | 13.8% | 27.3% | 40.6% | 68.8% | 41% | 41% | 41% |
| from A1 ² | | | | | | | | |
| Content of thinner³ | 7.8 | 9.5 | 8.7 | 7.8 | 7.8 | 0 | 4.1 | 3.9 |
| T-Peel ⁴ | | | | | | | | |
| [N/mm] | | | | | | | | |
| (7 d SCC) | 0 | 0.1 | 1.2 | 7.5 | 8.8 | 3.1 | 3.1 | 7.2 |
| (+28 d 70/100) | 0 | 0.4 | 1.1 | 2.0 | 0.7 | 2.3 | 2.3 | 2.4 |
| Tensile | | | | | | | | |
| strength ⁵ | | | | | | | | |
| [MPa](7 d SCC) | 30 | n.d. | 31 | 28 | n.d. | 24 | 23 | 28 |

“n.d.” stands for “not determined”
¹ content of amine A1 based on the sum total of the liquid constituents of the curing agent component in % by weight
² proportion of amine hydrogen equivalents from amine A1 based on the total number of amine hydrogen equivalents in the curing agent component
³parts by weight of thinner per 100 parts by weight of epoxides and amines
⁴ bonding of soft PVC to soft PVC
⁵ of the adhesive

TABLE 2
Composition and properties of examples 9 to 12.

| Example | 9 | 10 | 11 | 12 |
|---|---|---|---|---|
| Resin comp. | | | | |
| BADGE | 41.2 | 41.2 | 41.2 | 41.2 |
| DY-E | 3.8 | 3.8 | 3.8 | 3.8 |
| Rütasolv ® BP M | 3.2 | 3.2 | 3.2 | 3.2 |
| Quartz flour | 20.0 | 20.0 | 20.0 | 20.0 |
| Quartz sand | 115.8 | 115.8 | 115.8 | 115.8 |
| Coated CaCO₃ | 16.0 | 16.0 | 16.0 | 16.0 |
| Curing comp. | | | | |
| DMAPAPA | 6.0 | 4.0 | — | — |
| DMAPA | — | 1.0 | 4.0 | — |
| DMAP-MXDA | — | — | — | 6.5 |
| IPDA | 3.0 | 3.0 | 4.0 | 4.5 |
| LITE 3025 | 5.0 | 7.0 | 5.0 | 4.0 |
| Benzyl alcohol | 7.0 | 6.0 | 8.0 | 6.0 |
| Quartz flour | 37.0 | 37.0 | 37.0 | 37.0 |
| Quartz sand | 25.5 | 25.5 | 25.5 | 25.5 |
| Coated CaCO₃ | 16.5 | 16.5 | 16.5 | 16.5 |
| Content of amine A1 ¹ | 28.6% | 23.8% | 19.3% | 31.0% |
| Proportion of AH from | 48.8% | 40.7% | 35.5% | 37.9% |
| A1 ² | | | | |
| Content of thinner ³ | 17.3 | 15.3 | 19.3 | 15.4 |
| T-Peel ⁴ [N/mm] | | | | |
| (7 d SCC) | 6.3 | 8.0 | 5.2 | 2.5 |
| (+28 d 70/100) | 2.2 | 2.3 | 1.7 | 1.6 |

¹ content of amine A1 based on the sum total of the liquid constituents of the curing agent component in % by weight
² proportion of amine hydrogen equivalents from amine A1 based on the total number of amine hydrogen equivalents in the curing agent component
³ parts by weight of thinner per 100 parts by weight of epoxides and amines
⁴ bonding of soft PVC to soft PVC

Further tests were conducted as described below with the adhesives from examples 4 and/or 9:

Peel strength (T-Peel) was determined as described above with further soft PVC membranes as specified in table 3. In some cases, peel strength was also tested after 7 days under standard climatic conditions, followed by 28 days immersed in deionized water at room temperature, followed by 3 days under standard climatic conditions (+28d H₂O).

Lap shear strength was tested on hard PVC. For this purpose, composite specimens were produced by bonding two untreated hard PVC sheets in such a way that the overlapping adhesive bond had dimensions of 12×25 mm and a thickness of 2 mm and the sheets protruded at the top ends. After the composite specimens had been stored under standard climatic conditions for 7 days, lap shear strength was tested to DIN EN 1465 at a strain rate of 20 mm/min. Peel strength (T-Peel) was additionally determined on dry and moist concrete. For this purpose, a concrete garden slab was provided in the dry state under standard climatic conditions. Another garden slab was immersed in tap water for 24 h and then dabbed dry with a towel (=moist concrete). Three membrane strips (Sikaplan® WP 2110-21 HL, soft PVC sealing membrane for tunnel construction, from Sika) of 50×200 mm were applied to each of these concrete surfaces over an area of 50×150 mm with an adhesive thickness of 2 mm. After curing under standard climatic conditions for 7 days, the bonded membrane was pulled away from the concrete surface in accordance with DIN EN 14173 at an angle of 90° with a strain rate of 100 mm/min, and peel strength was evaluated in the middle 100 mm.

Peel strength (T-Peel) was additionally determined on a Kynar® metal. For this purpose, three membrane strips of 50×200 mm (Sarnafil® S 327-15 EL, soft PVC membrane for roof sealing, from Sika) were bonded to an aluminum sheet coated with polyvinylidene fluoride (Kynar® 500 from Arkema) over an area of 50×150 mm with an adhesive thickness of 2 mm without pretreatment. After curing under standard climatic conditions for 7 days, the bonded membrane was pulled away from the concrete surface in accordance with DIN EN 14173 at an angle of 90° with a strain rate of 100 mm/min, and peel strength was evaluated in the middle 100 mm.

The results are reported in table 3.

TABLE 3
Additional properties of examples 4 and/or 9.

| Example | 4 | 9 |
|---|---|---|
| T-Peel with Sarnafil ® | | |
| G 410-15 EL ¹ [N/mm] | | |
| (7 d SCC) | 4.5 | 6.4 |
| (+28 d H₂O) | n.d. | 4.4 |
| (+28 d 70/100) | 3.0 | 1.8 |
| T-Peel with Sarnafil ® | | |
| S 327-15 EL ¹ [N/mm] | | |
| (7 d SCC) | 7.2 | 6.1 |
| (+28 d H₂O) | n.d. | 4.1 |
| (+28 d 70/100) | 7.1 | 1.4 |
| T-Peel with Sikaplan ® | | |
| G-15 ¹ [N/mm] | | |
| (7 d SCC) | n.d. | 1.1 |
| (+28 d H₂O) | n.d. | n.d. |
| (+28 d 70/100) | n.d. | 1.0 |
| Lap shear strength (hard PVC) | | |
| [MPa] | | |
| (7 d SCC) | n.d. | 19.4 |
| T-Peel ² on dry | | |
| concrete [N/mm] | | |
| (7 d SCC) | 12.3 | n.d. |
| T-Peel ² on moist | | |
| concrete [N/mm] | | |
| (7 d SCC) | 10.5 | n.d. |
| T-Peel ³ on Kynar ® | | |
| metal [N/mm] | | |
| (7 d SCC) | 8.4 | n.d. |

“n.d.” stands for “not determined”
¹ bond of a soft PVC membrane for roof sealing, from Sika, top side to bottom side, in each case without pretreatment
² bond of a soft PVC membrane to concrete
³ bond of a soft PVC membrane to Kynar ® metal

1. A method for bonding a soft PVC membrane to a further substrate, comprising the steps of:
providing a two-component adhesive composition comprising a resin component and a curing agent component,
mixing the resin component and the curing agent component and any further components present in the adhesive by a suitable method,
applying the mixed adhesive to the soft PVC membrane and/or to the further substrate,
joining the substrates within the open time of the adhesive, and
curing the adhesive,
wherein the adhesive comprises
a resin component comprising at least one epoxy resin and
a curing agent component comprising
(a) at least one amine A1 having at least one dimethylamino group and at least one amine hydrogen, and
(b) at least one further amine A2 which has at least three amine hydrogens and is free of dimethylamino groups,
wherein the curing agent component, based on the sum total of all liquid or dissolved constituents present in the curing agent component, has a content of amines A1 of 10% to 45% by weight.

2. The method as claimed in claim 1, wherein the resin component contains at least one aromatic liquid epoxy resin.

3. The method as claimed in claim 1, wherein the amine A1 is selected from the group consisting of 2-dimethylaminoethylamine, 3-dimethylaminopropylamine, 4-dimethylaminobutylamine, 6-dimethylaminohexylamine, 2-(2-dimethylaminoethylamino)ethylamine, 2-(3-dimethylaminopropylamino) ethylamine, 3-(2-dimethylaminoethylamino)propylamine, 3-(3-dimethylaminopropylamino) propylamine, N-(3-dimethylaminopropyl)-1,3-bis(aminomethyl)benzene, N-(3-dimethylaminopropyl)-1,4-bis(aminomethyl)benzene, 2,4,6-tris(4-dimethylamino-2-azabutyl)phenol, bis(2-dimethylaminoethyl)amine, bis(3-dimethylaminopropyl)amine and bis(6-dimethylaminohexyl)amine.

4. The method as claimed in claim 1, wherein the number of amine hydrogen equivalents from amines A1 based on the total number of amine hydrogen equivalents in the curing agent component is in the range from 20% to 60%.

5. The method as claimed in claim 1, wherein the amine A2 is selected from the group consisting of 1,5-diamino-2-methylpentane, hexane-1,6-diamine, 2,2(4),4-trimethylhexane-1,6-diamine, 2-butyl-2-ethylpentane-1,5-diamine, isophoronediamine, 1,3-bis(aminomethyl)benzene, 1,4-bis(aminomethyl)benzene, 2,5-bis(aminomethyl)furan, 2,5-bis(aminomethyl)tetrahydrofuran, 1,3-bis(aminomethyl)cyclohexane, 1,4-bis(aminomethyl)cyclohexane, bis(4-aminocyclohexyl)methane, 1,2-diaminocyclohexane, 1,3-diaminocyclohexane, 1,4-diaminocyclohexane, 2(4)-methyl-1,3-diaminocyclohexane, 2,5(2,6)-bis (aminomethyl)bicyclo[2.2.1]heptane, N-benzylethane-1,2-diamine, N-furfurylethane-1,2-diamine, N-tetrahydrofurfurylethane-1,2-diamine, diethylenetriamine, triethylenetetramine, tetraethylenepentamine, dipropylenetriamine, N-(2-aminoethyl) propane-1,3-diamine, N,N′-bis (3-aminopropyl) ethylenediamine, bis (1,6-hexylene) triamine, phenalkamines, phenalkamides, polyamidoamines, amine-functional adducts of the amines mentioned with epoxides, and combinations of two or more of these amines.

6. The method as claimed in claim 1, wherein the amine A2 present is at least one amine A2-1 having an amine hydrogen equivalent weight of at least 80 g/eq.

7. The method as claimed in claim 6, wherein the amine A2 present is a combination of at least one amine A2-1 and at least one amine A2-2 having two primary amino groups and four amine hydrogens.

8. The method as claimed in claim 1, wherein the curing agent component contains a combination of 3-(3-dimethylaminopropylamino)propylamine, isophoronediamine and at least one amine selected from phenalkamines, phenalkamides and amine-functional adducts of N-benzylethane-1,2-diamine with at least one aromatic liquid epoxy resin.

9. The method as claimed in claim 1, wherein the adhesive contains at least one further ingredient selected from thinners, fillers, accelerators and surface-active compounds.

10. The method as claimed in claim 1, wherein the adhesive contains, based on 100 parts by weight of the sum total of all constituents containing epoxy and amine groups, not more than 30 parts by weight, of thinner.

11. The method as claimed in claim 1, wherein the adhesive contains, based on the overall adhesive, 60% to 90% by weight, of mineral fillers.

12. The method as claimed in claim 1, wherein the adhesive contains, based on the overall adhesive,
10% to 20% by weight of aromatic liquid epoxy resins,
1% to 4% by weight of reactive diluent containing epoxy groups,
3-(3-dimethylaminopropylamino)propylamine,
isophoronediamine,
at least one amine A2-1 having an amine hydrogen equivalent weight of at least 80 g/eq,
60% to 90% by weight of mineral fillers
and optionally further ingredients.

13. The method as claimed in claim 1, wherein the further substrate is selected from soft PVC, polyolefin, modified polyethylene, concrete, mortar, cement screed, fiber cement, brick, tile, natural stone, steel, polyvinylidene fluoride-coated metals and further plastics.

14. An adhesive bond obtained from the use as claimed in claim 1.

15. The adhesive bond as claimed in claim 14, wherein the peel strength value in each case is at least 1 N/mm, determined both after a) curing under standard climatic conditions for 7 days and b) curing under standard climatic conditions for 7 days, followed by storage at 70° C. and 100% relative humidity for 28 days, followed by storage under standard climatic conditions for 3 days, where, if the soft PVC membrane has been bonded to a further membrane, peel strength is determined to DIN EN 14173 at a strain rate of 100 mm/min, and where, if the soft PVC membrane has been bonded to a solid surface, peel strength is determined in accordance with DIN EN 14173 at a strain rate of 100 mm/min with a strain angle of 90° between the soft PVC membrane and the solid surface.
